(19) United States
(12) Patent Application Publication
(10) Pub. No.: US 2008/0123900 A1
(43) Pub. Date: May 29, 2008

(54) SEAMLESS TRACKING FRAMEWORK USING HIERARCHICAL TRACKLET ASSOCIATION

(75) Inventors: Yunqian Ma, Roseville, MN (US); Qian Yu, Los Angeles, CA (US); Isaac Cohen, Minnetonka, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/548,185

(22) Filed: Oct. 10, 2006

Related U.S. Application Data
(60) Provisional application No. 60/804,761, filed on Jun. 14, 2006.

(51) Int. Cl. G06K 9/00

(52) U.S. Cl. 382/103

(57) ABSTRACT

A tracking system that may initially take image sequences from sensors and regions of interest computed automatically, or defined by the operator, or provided by another approach or way. Tracklets may be initialized from the provided regions of interest. The tracklets of the same target may be associated with each other to form another tracklet of another level. Tracklets may be merged to form tracks. Association of tracklets or tracks may be effected at various levels in a hierarchical manner. Also, association of observations, tracklets and tracks may be based on a computation of distance, i.e., similarity in motion and appearance.

The present application claims the benefit of U.S. Provisional Application No. 60/804,761, filed Jun. 14, 2006. U.S. Provisional Application No. 60/804,761, filed Jun. 14, 2006, is hereby incorporated by reference.

### BACKGROUND

The present invention pertains to tracking and particularly to tracking targets that may be temporarily occluded or stationary within the field of view of one or several sensors or cameras.

### SUMMARY OF THE INVENTION

The invention is a tracking system that takes image sequences acquired by sensors, and computes trajectories of moving targets. Targets could be occluded or stationary. Trajectories may consist of small number of instances of the target, i.e., tracklets estimated from the field of view of a sensor or corresponds to small tracks from a network of overlapping or non overlapping cameras. The tracklets may be associated in a hierarchical manner.

### BRIEF DESCRIPTION OF THE DRAWING

FIG. 1 is a graph of nodes reflecting observations of corresponding detected blobs;

FIG. 2 shows a general framework of a tracklets association system;

FIG. 3 illustrates further detail of the system for the initialization of tracklets from a selected region and for a hierarchical association of tracklets;

FIG. 4 shows a relationship between tracklets and clustering;

FIG. 5 shows a number sensors or cameras in a tracking layout;

FIG. 6 reveals several tracklets from one or several fields of view and merging of tracklets;

FIG. 7 shows histograms for targets of several tracklets; and

FIG. 8 is an application for the tracking system at an airport.

### DESCRIPTION

A common problem encountered in tracking applications is attempting to track an object that becomes occluded, particularly for a significant period of time. Another problem is associating objects, or tracklets, across non-overlapping cameras, or between observations of a moving sensor that switches fields of view. Still another problem is updating appearance models for tracked objects over time. Instead of using a comprehensive multi-object tracker that needs to simultaneously deal with these tracking challenges, a framework that handles each of these problems in a unified manner by the initialization, tracking, and linking of high-confidence tracklets, may be presented. In this track/suspend/match paradigm, a scene may be analyzed to identify areas where tracked objects are likely to become occluded. Tracking may then be suspended on occluded objects and re-initiated when they emerge from the occlusion. Then the suspended tracklets may be associated, or matched with the new tracklets using a kinematic model for object motion and a model for object appearance in order to complete the track through the occlusion. Sensor gaps may be handled in a similar manner, where tracking is suspended when the operator changes the field of view of the sensor, or when the sensor is automatically tasked to scan different areas of the scene and then is re-initiated when the sensor returns. Changes in object appearance and orientation during tracking may also be seamlessly handled in this framework. Tracked targets are associated within the field of view of a sensor or across a network of sensors. Tracklets may be associated hierarchically to merge instances of the target within or across the field of view of sensors.

The goal of object tracking is to associate instances of the same object within the field of view of a sensor or across several sensors. This may require using a prediction mechanism to disambiguate association rules, or to compensate for incomplete or noisy measurements. The objective of tracking algorithms is to track all the relevant moving objects in the scene and to generate one trajectory per object. This may involve detecting the moving objects, tracking them while they are visible, and re-acquiring the objects once they emerge from an occlusion to maintain identity. In surveillance applications, for example, occlusions and noisy detection are very common due to partial or complete occlusions of the target by other targets or objects in the scene. In order to analyze an individual's behavior, it may be necessary to track the individual both before and after the occlusion as well as to identify both tracks as being the same person. A similar situation may arise in aerial surveillance. Even when seen from the air, vehicles can be occluded by buildings or trees. Further, some aerial sensors can multiplex between scenes. Objects can also change appearance, for instance when they enter and exit shadows or their viewing direction changes. Such an environment requires a tracking system that can track and associate objects despite these issues.

A system which adapts to changes in object appearance and enables tracking through occlusions and across sensor gaps by the initialization, tracking, and associating tracklets of the same target may be desired. This system can handle objects that accelerate as well as change orientation during the occlusion. It can also deal with objects that change in appearance during tracking, for example, due to shadows.

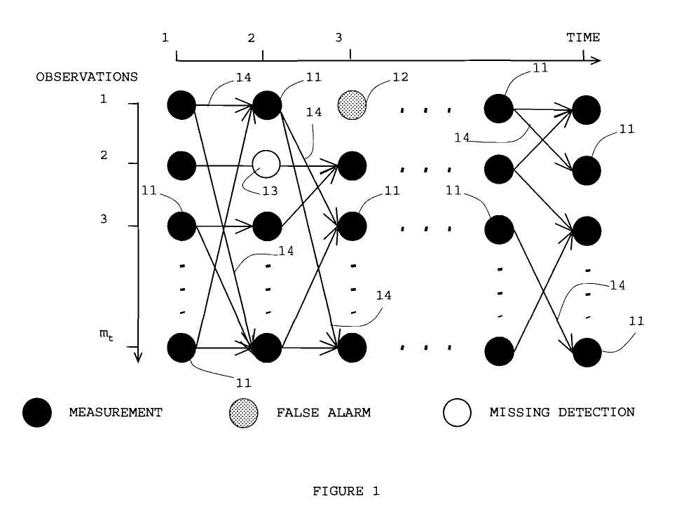

The multiple target tracking problem may be addressed as a maximum a posteriori estimation process. To make full use of the visual observations from the image sequence, both motion and appearance likelihood may be used. A graphical representation of all observations over time may be adopted. (FIG. 1.) Tracking may be formulated as finding multiple paths in the graph. Multiple target tracking is a key component in visual surveillance. Tracking may provide a spatio-temporal description of detected moving regions in the scene. This low level information can be critical for recognition of human actions in video surveillance. In the present visual tracking situation, observations are the detected moving blobs. A challenging part of the visual tracking situation may come from incomplete observations due to occlusions, noisy foreground segmentation or regions of interest selection, and stop-and-go motion.

The present system may be for multiple tracking in wide area surveillance. This system may be used for tracking objects of interest in single or multiple stationary camera modes as well as moving camera modes. An objective is to track multiple targets seamlessly in space and time. Problems in visual tracking may include static occlusion caused by stationary background such as buildings, vehicles, and so forth, and dynamic occlusion caused by other moving objects in the scene. In this situation, an estimated trajectory of targets may be fragmented. Moreover, for multiple cameras with or without overlap, targets from different cameras might have different appearances due to illumination changes or different points of view.

The system may include a tracking approach that first forms tracklets (locally connected several frames) and then merges the tracklets hierarchically in the sense of various levels. Then one may assign the track of, for example, a specific person, a unique track identification designator (ID) and form a meaningful track.

The multiple target tracking may be performed in several steps. The first step computes small tracks, i.e., tracklets. A tracklet is a sequence of observations or frames with a high confidence of being reported from the same target. The tracklet is usually a sequence of observations before the target gets occluded where it is blocked by an obstruction, or goes out of the field of view of the camera or results in very noisy detection. Motion detection may be adopted as an input, which provides observations. Each observation may be associated with its neighbor observations to form tracklets.

In another step, the tracklets may be associated into a meaningful track for each target hierarchically using the similarity (distance) between the tracklets. The tracklet concept may be introduced to divide the complex multiple target tracking problem into manageable sub-problems. Each tracklet may encode the information of kinematics and appearance, which is used to associate the tracklets that correspond to the same target into a single track for each target in the presence of scene occlusions, tracking failures, and the like.

There are several steps in using this system. The video acquisition may take input video sequences. The image processing module may first perform motion detection (background subtraction, or similar methods). The input for a tracking algorithm includes the regions of interest (such as blobs computed automatically, or provided manually by an operator, or obtained by another way) and the original image sequence. Tracklets may be created by locally associating observations with high confidence of being from the same target. To form tracklets, a “distance” between consecutive observations should be determined. The “distance” is defined according to a similarity measure, which can be defined using motion and appearance characteristics of the target. The procedure of forming a tracklet may be suspended when the tracker's confidence is below a predefined threshold. The present system currently uses a threshold of the similarity measure to determine a suspension of the single tracker.

After the tracklets are formed, they may be grouped. Here, a distance may be defined between two tracklets for selecting the tracklets representing the same object in the scene. Both kinematics and appearance constraints may be considered for determining the similarity of two tracklets. The kinematics constraint may require two associated tracklets to have similar motion characteristics. For the appearance constraint, a distance may be introduced between two sequences of appearances, e.g., a Kullback-Leibler divergence defined based on the color appearance between two tracklets. Also, each tracklet may be represented by a set of vectors (one vector corresponding to one frame observation). The distance between two sets of vectors may be determined by many other methods, such as: correlation, spatial registration, mean-shift, kernel principal component analysis, using a kernel principal angle between two subspaces, and the like

In a multiple targets tracking situation, one approach is to track multiple target trajectories over time given noisy measurements provided by motion detections. The targets' positions and velocities may automatically be initialized and do not necessarily require operator interaction. The measurements in the present visual tracking cannot necessarily be regarded as punctual measurements. The detector usually provides image blobs which contain both the estimated location, size and the appearance information as well. Within any arbitrary time span [0,T], there may be K unknown number of targets in the monitored scene. Let yₜ={yₜⁱ:i=1, . . . , nₜ} denote the observations at time t, and Y=∪_{tε[1,T]}yₜ be the set of all the observations within the duration [0,T]. The multiple target tracking may be formulated as finding the set of K best paths {τ₁,τ₂ . . . , τ_{K}} in the temporal and spatial space, where K is unknown. Let τₖ denote a track by the set of its observations: τₖ={τₖ(1),τₖ(2), . . . , τₖ(T)} where τₖ(t)εyₜ represents the observation of track τₖ at time t.

A graphical representation G=<V,E> of all measurements within time [0,T] may be utilized. It may be a directed graph that consists of a set of nodes V={yₜ^{k}:t=1, . . . T, k=1, . . . , K}. Considering the existence of missing detection, one special measurement of yₜ⁰ to represent the null measurement at time t may be added. An edge (yₜⁱ,yₜ₊₁^{j})εE is defined between two nodes in consecutive frames based on proximity and similarity of the corresponding detected blobs or targets. To reduce the amount of edges 14 defined in the graph, one may consider only edges for which the distance (motion and appearance) between two nodes 11 is more than a pre-determined threshold. An example of such a graph is in FIG. 1. In each time instant, there are mₜ observations. The shaded node 12, which does not belong to any track, represents a false alarm. For instance, a false alarm could be a movement of trees in the wind. The white node 13 represents a missing observation, inferred by the tracking.

The multiple targets tracking problem may be formulated as a maximum a posteriori (MAP), given the observations over time one may find K best paths {τ_{1, . . . , K}} through the graph of measurements with the following. The K paths multiple target tracking may be extended to a MAP estimate as follows,

τ*_{1, . . . , K}=argmax(P(Y|τ_{1, . . . , K})P(τ_{1, . . . , K})). (1)

Since the present measurements are image blobs, besides position and dimension information, an appearance model may also be considered for the visual tracking. To make use of the visual cues of the observations, one can introduce both motion likelihood and appearance to facilitate the present tracking task. By assuming that each target is moving independently, the joint likelihood of the K paths over time [1, T] can be represented as,

$$P ( Y \vert {τ}_{1 , … , K} ) = {\prod }_{k = 1}^{K} {P}_{motion} ( {τ}_{k} ( 1 ) , … , {τ}_{k} ( T ) ) {P}_{color} ( {τ}_{k} ( 1 ) , … , {τ}_{k} ( T ) ) . \qquad ( 2 )$$

### The joint probability is defined by the product of the appearance and motion probabilities.

A constant velocity motion model in 2D image plane can be considered. One may note that for tracking in difference space, the state vector may be different; for example, one can augment the state vector with position on a ground plane if planar motion can be assumed. One may denote xₜ^{k} the state vector of the target k at time t to be [lₓ,l_{y},w,h,iₓ,i_{y}] (position, width, height and velocity in 2D image), and consider a state transition described by a linear kinematic model,

xₜ₊₁^{k}=A^{k}xₜ^{k}+wₜ^{k}, (3)

where xₜ^{k} is the state vector for target k at time t. wₜ^{k} may be assumed as normal probability distributions, w≈N(0,Q). A^{k} is the transition matrix. Here, a constant velocity motion model may be used. The observation yₜ^{k}=[uₓ,u_{y},w,h] contains the measurement of a target position and size in 2D image plane. Since observations may contain false alarms, the observation model could be represented as:

$${y}_{t}^{k} = \{ \begin{matrix}{H}^{k} {x}_{t}^{k} + {v}_{t}^{k} & if from target \\ {δ}_{t} & false alarm ,\end{matrix} \qquad ( 4 )$$

where yₜ^{k} represents the measurement which could arise either from a false alarm or from the target. δₜ is the false alarm rate at time t. The measurement may be modeled as a linear model of a current state if it is from a target. Otherwise, it may be modeled as a false alarm δₜ, which is assumed to be a uniform distribution. One may assume vₜ^{k} to be normal probability distributions, v≈N(0,R).

One may let \hat{τ}ₖ(tᵢ) and \hat{P}ₜ(τₖ) denote the posterior estimated state and posterior covariance matrix of estimated error at time t of τₖ(t). The motion likelihood of track τₖ at time t may be represented as Pₘₒₜᵢₒₙ(τₖ(t)|\hat{τ}ₖ(t−1)). The τₖ(t) is the associated observation for track k at time t and \hat{τ}ₖ(t−1) is the posterior estimate of track k at time t−1 which can be obtained from a Kalman filter. Given the transition and observation model in the Kalman filter, the motion likelihood then may be written as,

$${P}_{motion} ( {τ}_{k} ( t ) \vert {\hat{τ}}_{k} ( t - 1 ) ) = \{ \begin{matrix}\frac{1}{{( 2 π )}^{3 / 2} det ( {S}_{t} ( {τ}_{k} ) )} exp ( \frac{- {e}^{T} {S}_{t}^{- 1} ( {τ}_{k} ) e}{2} ) & If deteted \\ {p}_{M} & If missed ,\end{matrix} \qquad ( 5 )$$

where e=yₜ^{k}−HA\hat{τ}ₖ(t−1) and Sₜ(τₖ)=H(A\hat{P}ₜ₋₁(τₖ)A^{T}+Q)H^{T}+R, and p_{M} is the missing detection rate assumed as a prior knowledge.

In order to model the appearance of each detected region, one may adopt a non-parametric histogram based appearance of the image blobs. All RGB bins may be concatenated to form a one dimension histogram. Between two image blobs at two consecutive frames t−1 and t, a Kullback-Leibler distance (KL) may be defined as follows,

$${P}_{color} ( {τ}_{k} ( t ) \vert {\hat{τ}}_{k} ( t - 1 ) ) = \frac{1}{2} {\sum }_{c = r , g , b} ( {P}_{i} ( c ) - {P}_{j} ( c ) ) log ( \frac{{P}_{i} ( c )}{{P}_{j} ( c )} ) . \qquad ( 6 )$$

### Other appearance models may be introduced into this framework as well.

Given the motion and appearance model, one may associate a cost to each edge defined between two nodes of the graph. This cost may combine the appearance and motion likelihood models presented herein. The joint likelihood of K paths in an equation for joint likelihood may then be represented as follows,

$$P ( Y \vert {τ}_{1 , … , K} ) = {\prod }_{k = 1}^{K} {P}_{motion} ( {τ}_{k} ( t ) \vert {\hat{τ}}_{k} ( t - 1 ) ) {P}_{color} ( {τ}_{k} ( t ) \vert {\hat{τ}}_{k} ( t - 1 ) ) . \qquad ( 7 )$$

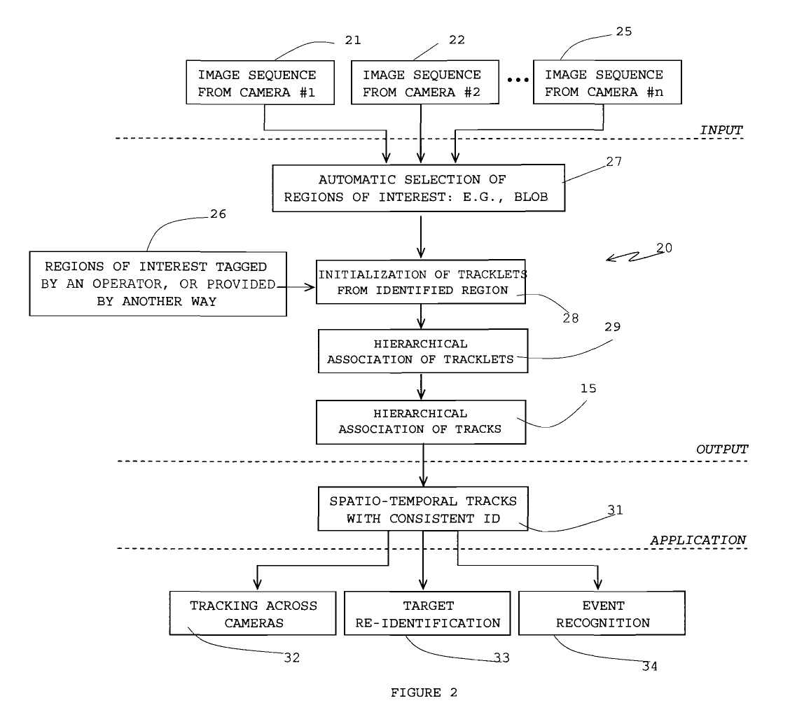

FIG. 2 shows a general framework of a tracklets association system 20. One or more image sequences may be input to system 20 from cameras 21, 22 and 25 which may represent the first, second, and nth cameras. The total number of cameras may be n, or there may be just one camera. The inputs to system 20 from each of the cameras may be video clips, image sequences or video streams of various spatial and temporal resolutions. The clips may be fed into an algorithm for automatic selection of regions of interest (e.g., blob) (module 27), or objects of interest could be provided by another way, such as manually by the video operator or the end user. The region may be essentially the target matter or targets which are to be tracked. One possible criterion utilized to define these regions is by grouping pixels using motion or change in intensity compared to a known model or another way allowing delineating the objects of interest.

The output of module 27 may go to a module 28 for initialization of tracklets from the selected regions. A selection of regions of interest module 26 may provide regions of interest selected for tracking via automatic computation, manual tagging, or the like. Regions of interest tagged by an operator or provided by other ways as provided by module 26 may go to module 28.

The first tracklet of initialization may include a preset number of frames. There may appear to be a blob to start which could be of several persons that may result in several tracklets. Or a person may be represented by several clusters. The system 20 process image sequences in an arbitrary order (i.e., forward or backward).

A filtering approach, linear or non-linear, may aid in tracking multiple targets. One target may be selected for tracking. Following the target may involve several tracklets, whether of a field of view of one camera or several fields of view of more than one camera whether overlapping or not.

An output from module 28 may go to a module 29 for a hierarchical association of tracklets. The tracklets may be associated according to several criteria, e.g., appearance and motion, as described herein. An output of module 29, which may be a combination of tracklets or sub-trajectories of the same target of object into tracks or trajectories, can go to a module 15 for a hierarchical association of tracks. There may be tracks for several targets. The output of module 15, which is an output of system 20, may go to module 31. Module 31 may be for spatio-temporal tracks having consistent identification designations (IDs) or equivalents. A track of one and the same object would have a unique ID. An application of an output of module 31 may be for tracking across cameras (module 32), target re-identification (module 33), such as in a case of occlusion, and event recognition (module 34). Event recognition of module 34 may be based on high level information for noting such things as normal or non-normal behavior of the apparently same tracked object. Also, if there are tasks or complex events, there may be a basis for highlighting a recognition behavior of the object.

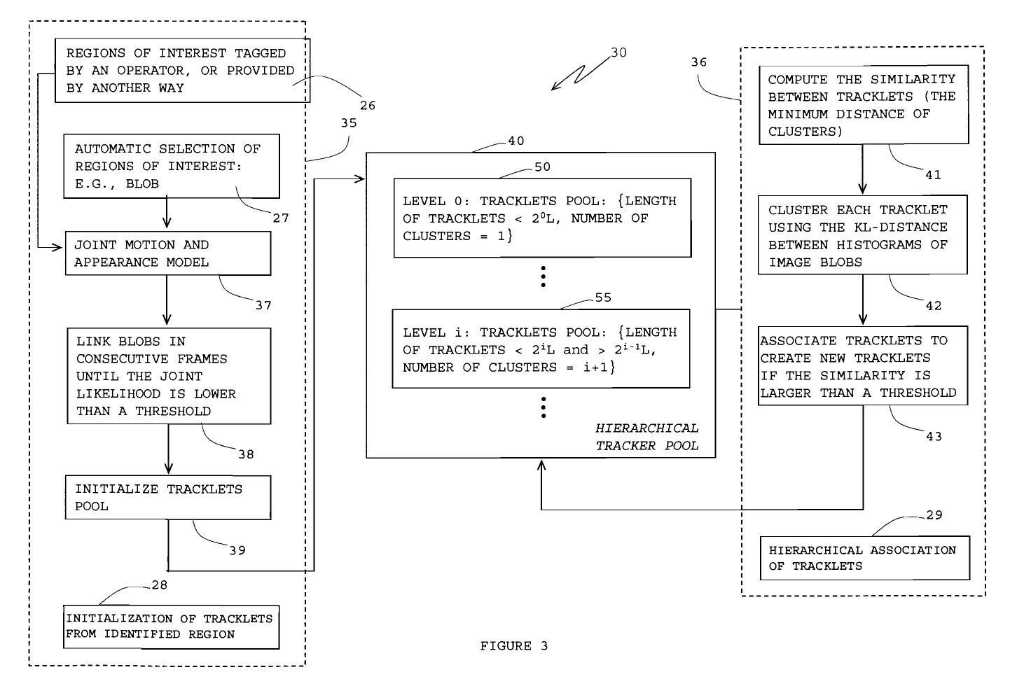

A diagram of FIG. 3 illustrates further detail for a system 30 of the initialization of tracklets from a selected region and the hierarchical association of tracklets. In region 35 of the diagram, the regions of interest are computed automatically or provided by an operator of module 26 to a module 37. Also, in area 35 is a module 28 for the initialization of tracklets from the selected or identified region which is indicated in FIG. 2. There may be regions of interest tagged by an operator or provided by other ways as provided by module 26 to module 37. For associating tracklets, module 37 may be a joint motion and appearance model module for hierarchically associating the tracklets. A joint likelihood of similarity may be derived from the model of module 37 with an output to a module 38. Module 38 deals with linking blobs in consecutive frames until a joint likelihood is below a set threshold. An output from module 38 may go to an initialize tracklets pool module 39. After initializing the tracklet pool, the tracklet pool will be changed iteratively till convergence. An output of module 39 may go to a hierarchical tracker pool module 40. The output of module 39 will still be placed in the tracklet pool. The association procedure will stop until the tracklet pool stops to change.

Region 36 of the diagram of FIG. 3 may include a basis for the hierarchical association of tracklets as noted in module 29 for FIGS. 2 and 3. A module 41 indicates a computation of a similarity between tracklets. This computation may be of various approaches. For example, module 42 reveals a clustering of each tracklet using a KL distance between histograms of image blobs. Then a minimum distance of the resultant clusters may be a basis for the similarity between tracklets. The output of module 42 may go to a module 43 where there is an association of tracklets to create new tracklets if the similarity is larger than a set threshold. The corresponding old tracklets will be removed while the new tracklets will be added into the tracklet pool. The tracklets formed in module 43 may be in a form of an output to the hierarchical track pool module 40. Module 43 will cause the change of the tracklet pool until convergence.

In the hierarchical tracker pool module 40 are shown the various levels of the hierarchy of tracklets, with tracks to follow. Block 50 shows a level 0 of the tracklets pool. The level here indicates the length of tracklets. The initial tracklet pool could contain tracklets in multiple levels, for example, several level 0 tracklets and several level 3 tracklets as long as the tracklets can be formed in the tracklet initialization. The level of a track may determine how many clusters represent the tracklet. The length of the tracklets at this level is less than 2⁰L, and the number of clusters here is one. Block 55 shows a level i of the tracklets pool, and represents the other levels of the hierarchy beyond level 0. The length of the tracklets for the respective level i (i=1, 2 . . . ) is less than 2ⁱL. Or one could say that if the length of the tracklet is less than 2ⁱL, but longer than 2ⁱ⁻¹L, then the tracklet is in level i. The number of clusters is equal to i+1. The next level may be level 1 where the tracklets are brought into one track in accordance with proximity. At level 2, clustering may be implemented, such as in accordance with appearance. After this clustering, there may be a basis for going back to level 1 with a new appearance from the resulting cluster, to be associated with clusters of one or more other tracklets. Then there may be a progression to level 2 for more clustering. A certain interaction between levels 2 and 1 may occur. The process may proceed to a level beyond level 2. The tracklets in the tracklet pool may come from one or more cameras.

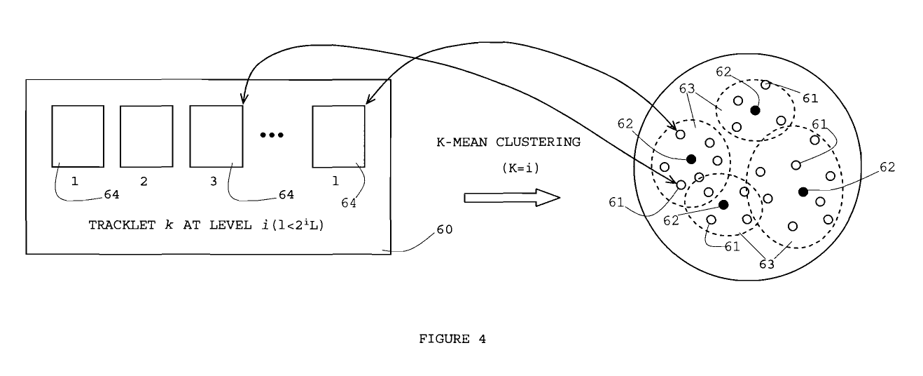

FIG. 4 shows a relationship between tracklets and clustering. Illustrated is present tracking using clustering. Shown is K-mean clustering (K=i) for a tracklet k at a level i (l<2ⁱL). Each white node 61 represents a color histogram (i.e., a part of the appearance model) of each blob 64 of a tracklet 60. The distance between each node 61 is the KL distance of the corresponding histograms. The dark node 62 represents a center of a cluster 63. The minimum distance between two tracklets' cluster centers 62 represents the similarity between two tracklets.

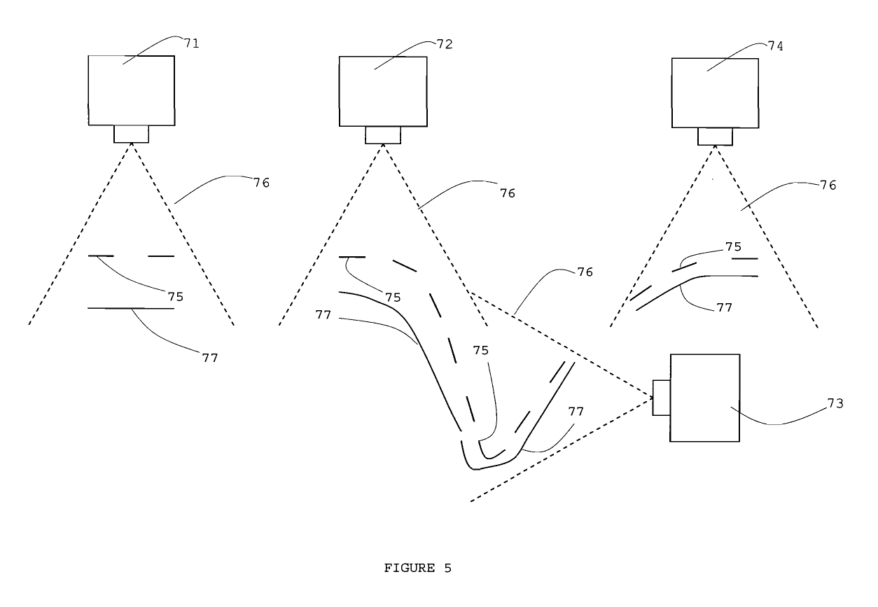

FIG. 5 shows a number sensors or cameras 71, 72, 73 and 74 in a tracking layout. There may be more or fewer cameras. For each camera, there may be tracklets 75 within its field of view 76. The fields of view 76 for the cameras are non-overlapping except for those of cameras 72 and 73. The tracklets 75 may be associated with each other to form a trajectory or track 77 within a field of view 76 of a respective camera. Their association indicates that the tracklets 75 are of the same object and the resulting track or trajectory 77 has a sense of completeness within the respective field of view. Tracking will first generate a hierarchy tracklet pool and the association between tracklets will change the pool until convergence, i.e., no more tracklets can be associated for the respective camera. The final output of the tracking is a target with a consistent ID within and across multiple cameras.

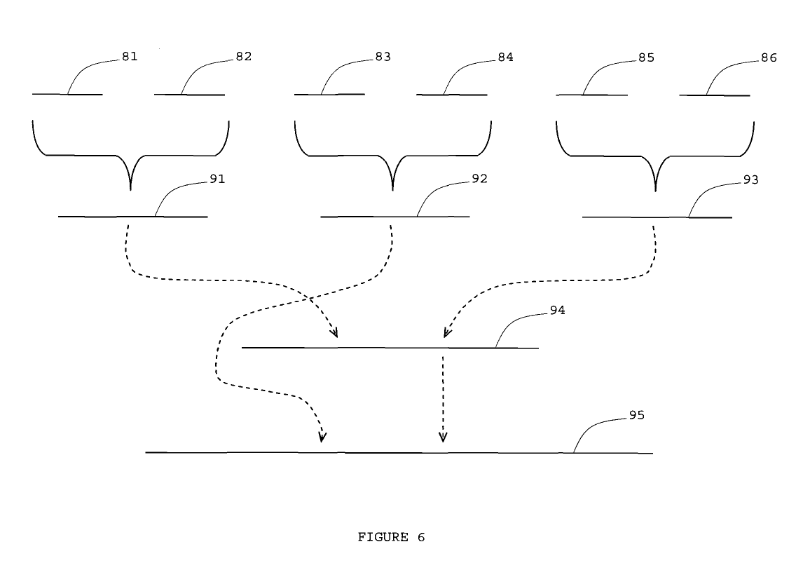

FIG. 6 displays a tracklet hierarchy from a camera. Tracklets of similar appearances (which have similarity of their respective clusters) may be merged. For example, one may look to clusters for the merging of observations (or frames) 81 and 82 into an initial tracklet 91. Clusters relating to observations 83 and 84 may form a cluster relating to a tracklet 92, which is a merging of the two observations 83 and 84. Observations 85 and 86 may have clusters put together as a cluster relating to a tracklet 93, which is a merging of the two observations. Tracklet 92 could fall out of future consideration but it may stay in the game. Since the clusters of tracklets 91 and 93 appear similar, the respective tracklets may be merged into a higher level tracklet 94 with a corresponding appearance cluster. This cluster may now have a new appearance that has significant similarity with the appearance of the cluster of tracklet 92. Thus, tracklet 92 may be merged with tracklet 94 into a track 95. This multi-level merging of tracklets may be regarded a hierarchical association of the tracklets.

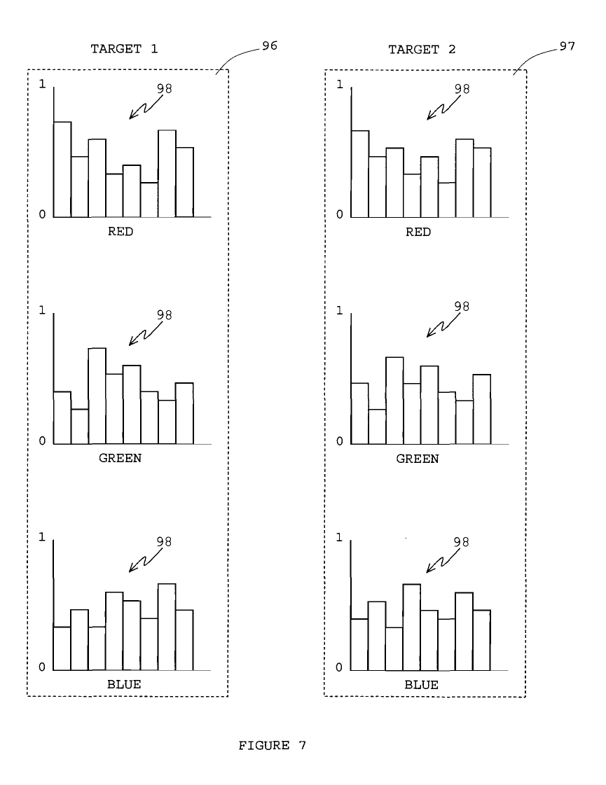

An example of a cluster on appearance of a tracklet for comparison may involve colors' histograms of several targets of respective tracklets. Noting similarity or non-similarity of the histograms indicates the corresponding blobs to be the same object or not the same object, respectively. The object may be a target of interest. FIG. 7, as an illustrative example, shows two sets of histograms 96 and 97 of targets (1 and 2) of two tracklets. Each histogram for the primary colors, red, green and blue, has a normalized indication on the ordinate axis for each of the eight bins 98 of each graph for the targets. The difference of the magnitudes of the corresponding bins for each color may be noted for the two targets. The similarity may be indicated by formula (9) (stated herein) where i is the bin number and P(c) is a normalized magnitude of each of the bins for target 1 and target 2. The formula reveals the differences of the corresponding bins for the respective colors. As the distance (i.e., differences) approaches zero, the more likely targets 1 and 2 are the same object. A set of histograms may be regarded as a color signature for the respective object.

Similarity of motion (i.e., kinematics) may also be a factor in determining whether the target of one tracklet is the same object as the target of another tracklet for purposes of associating and merging the two tracklets. An observation of a target may be made at any one time by noting the velocity and position of the target of one tracklet, and then making a prediction or estimate of the velocity and position of a target of another tracklet. If an observed velocity and position of the target of the other tracklet is close to the prediction or estimate of its velocity and position, then a threshold of similarity of motion may be met for asserting that the two targets are the same object. Thus, the two tracklets may be merged.

Several targets of respective tracklets can be checked for likelihood of similarity for purposes of merging the tracklets. For example, one may note tracklet 1 of a target 1, tracklet 2 of a target 2, tracklet 3 of a target 3, tracklet 4 of a target 4, and so on. One may use a computation involving clusters with appearance and motion models as described herein. Target 1 and target 2 may be more similar to each other than target 1 and target 3 are to each other. The distance or computation of similarity of targets 1 and 2 may be about 30 percent and that of targets 1 and 3 may be about 70 percent. The distance or computation of similarity of targets 1 and 4 may be about 85 percent, which meets a set threshold of 80 percent for regarding the targets as the same object. Thus, targets 1 and 4 can be regarded as the same object, and tracklets 1 and 4 may be merged into a tracklet or track. For illustrative examples of objects, targets 1, 2, 3 and 4 may be noted to be a first person, a second person, a third person and a fourth person, respectively. According to the indicated percentages and threshold, the first and second persons would not be considered as the same person, and the first and third persons would not be regarded as the same person, but the first and fourth persons may be considered as the same person.

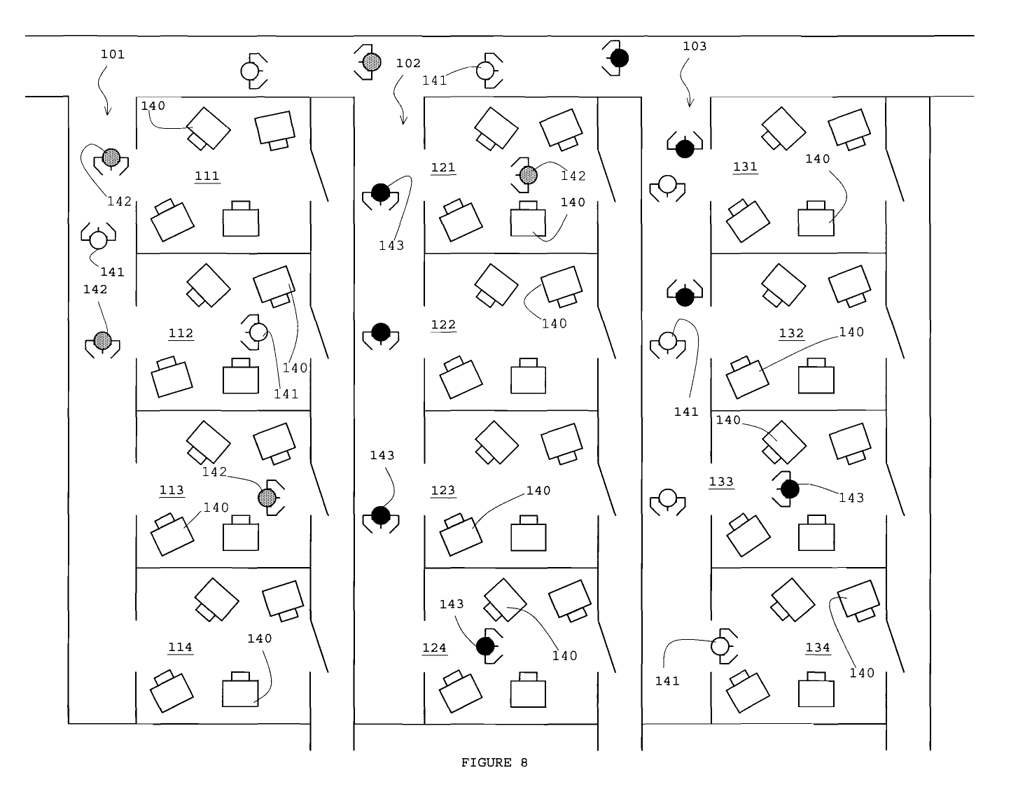

FIG. 8 is a top view of an illustrative sensor or camera layout in a large facility such as an airport for the present tracking system. There may be three concourses 101, 102 and 103. Concourse 101 may have gates 111, 112, 113 and 114, concourse 102 may have gates 121, 122, 123 and 124, and concourse 103 may have gates 131, 132, 133 and 134. Each gate may have four sensors or cameras 140 in the vicinity of the respective gate. They may be inside the gate area or some may be outside of the area. There may be targets (e.g., persons) 141, 142 and 143 walking about the concourses and gates. These targets 141, 142 and 143 may be white, gray or black, respectively. The multiple presences of these targets may instead be regarded as instances of a target at various points of a track over a period of time.

Each camera 140 may provide a sequence of images or frames of its respective field of view. The selected regions could be motion blobs separated from the background according to motion of the foreground relative to the background, or be selected regions of interest provided by the operator or computed in some way. These regions may be observations. Numerous blobs may be present in these regions. Some may be targets and others false alarms (e.g., trees waving in the wind). The observations may be associated according to similarity to obtain tracklets of the targets. Because of occasional occlusions or lack of detection of a subject target, there may be numerous tracklets from the images of one camera. The tracklets may be associated, according to similarity of objects or targets, with each other into tracklets of a higher level in a hierarchical manner, which in turn may result in a track of the target in the respective camera's field of view. Tracks from various cameras may be associated with each other to result in tracks of higher levels in a hierarchical manner. The required similarity may meet a set threshold indicating the tracklets or targets to be of the same target. A result may be a track of the target through the airport facility as depicted in FIG. 8. The track may have a unique ID. Tracks of other targets of the cameras' fields of view may also be derived from image sequences at the same time.

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

What is claimed is:

1. A tracking system comprising:
a selection of regions of interest module;
an initialization of tracklets module connected to the selections of regions of interest module; and
a hierarchical association of tracklets module connected to the initialization of tracklets module.

2. The system of claim 1, wherein the selection of regions of interest module provides regions of interest selected for tracking via automatic computation, manual tagging, or the like.

3. The system of claim 1, further comprising at least one camera for providing image sequences to an input of the selection of regions of interest module.

4. The system of claim 1, wherein the hierarchical association of tracklets module comprises a plurality of levels of tracklets.

5. The system of claim 4, wherein the tracklets of one or more levels are associated with each other to form a tracklet of another level.

6. The system of claim 4, wherein the tracklets of one or more levels are associated with each other to form a track.

7. The system of claim 5, wherein the tracklets are associated with each other according to a similarity of targets of the respective tracklets.

8. The system of claim 7, wherein the similarity of targets is based on a comparison of motion and appearance models of the respective targets.

9. The system of claim 4, wherein the tracking system may run backward or forward to review blob, target, tracklet and/or track origin or development.

10. The system of claim 1, further comprising a hierarchical association of tracks module connected to the hierarchical association of tracklets module.

11. The system of claim 10, wherein:
the hierarchical association of tracks module has an output for providing spatio-temporal tracks of targets; and
a track of a specific target may be assigned a unique identification designation.

12. The system of claim 11, wherein an application of the output of the hierarchical association of tracks module comprises:
a tracking across more than or at least one camera;
a re-identification of a target; and/or
a recognition of an event.

13. The system of claim 11, wherein the spatio-temporal tracks of a target are associated with each other to form tracks of various levels in a hierarchical manner.

14. A method for tracking comprising:
initializing tracklets from region(s) of interest;
implementing a motion and appearance model of the region(s) of interest;
associating blobs from the region(s) of interest in consecutive frames until a likelihood of the blobs being the same is lower than a set threshold;
initializing a tracklets pool;
computing a similarity between tracklets;
associating tracklets to create new tracklets if the similarity is greater than a threshold; and
adding the new tracklets to a hierarchical tracklet pool.

15. The method of claim 14, wherein the region(s) of interest are computed automatically, provided by a system operator, or the like.

16. The method of claim 14, wherein a similarity between tracklets is based on motion and appearance models.

17. The method of claim 14, further comprising merging tracklets to form tracks.

18. The method of claim 17, the tracklets are associated with each other to form tracklets of various levels of a hierarchy.

19. A framework for tracking comprising:
means for providing images of an area of surveillance;
means for selecting automatically, manually, or the like, regions of interest from the images;
means for obtaining observations of targets from the regions of interest;
means for associating observations of targets into m level tracklets;
means for associating the m level tracklets into m+1 level tracklets; and
wherein:
m is any numeral;
associating observations indicates that the observations have a likelihood being of the same target; and
associating tracklets indicates that the tracklets have a likelihood being of the same target.

20. The framework of claim 19, wherein certain tracklets are associated with each other to form tracks.

21. The framework of claim 20, wherein the tracks are associated with each other to form tracks of various levels in a hierarchical manner.

22. The framework of claim 21, the tracks are associated with each other according to a similarity of motion and appearance models of targets of the respective tracks.
